(19) United States
(12) Patent Application Publication
(10) Pub. No.: US 2026/0063823 A1
(43) Pub. Date: Mar. 5, 2026

(54) METHODS AND SYSTEMS FOR STRAIN-BASED IN SITU STRESS INITIALIZATION

(71) Applicant: ROCKENG INC., Kingston (CA)

(72) Inventor: Katherine KALENCHUK, Kingston (CA)

(21) Appl. No.: 19/040,250

(22) Filed: Jan. 29, 2025

Related U.S. Application Data
(63) Continuation of application No. PCT/CA2024/051150, filed on Sep. 4, 2024.

(51) Int. Cl. G01V 20/00

(52) U.S. Cl. CPC G01V 20/00

(57) ABSTRACT

Methods and systems are provided for initializing stress conditions in a numerical model using a strain-based stress initialization approach. A numerical model representation of a geomechanical system including one or more geomechanical domains is generated. A set of verified strain-initializing boundary conditions are generated for initializing a stress state of the numerical model, based on material properties and constitutive models of the one or more geomechanical domains and a global stress tensor corresponding to the geomechanical system. An in situ stress state of the numerical model is simulated by applying the verified strain-initializing boundary conditions to the numerical model and a simulated in situ stress tensor distribution is output based on the simulated in situ stress state. The disclosed methods and systems may enable improved numerical model accuracy for informing geomechanical design and operational decisions associated with mining, geotechnical and civil engineering applications.

### CROSS-REFERENCE TO RELATED APPLICATION

The present application is a continuation of PCT International Application PCT/CA2024/051150, titled “METHODS AND SYSTEMS FOR STRAIN-BASED IN SITU STRESS INITIALIZATION”, filed on Sep. 4, 2024, the entire contents of which are incorporated herein by reference.

### FIELD

The present disclosure relates to the field of geomechanical modeling, and more specifically, to modeling an in situ stress state in a geomechanical system, and yet more specifically, to strain-based stress initialization to produce geologically realistic in situ stress conditions for numerical analyses in geomechanical and geotechnical applications, such as natural resource extraction operations and/or the construction of surface or underground excavations in rock.

### BACKGROUND

Numerical modelling has become one of the most widely used design tools in geomechanics and rock engineering. In numerical modeling, rock mass behavior can be simulated with varying levels of detail and complexity, providing insights into rock mass response to the construction of underground and surface excavations in rock.

Rock mass behavior is strongly influenced by the in situ stress field present within the rock mass. Understanding the in situ stress field in a rock mass is particularly important for mining, geotechnical and civil engineering applications such as subsurface excavations, natural resource extraction, underground storage etc. When an excavation in rock is created, the stress state of the rock mass changes. To effectively understand changes in stress state, it is important to establish an accurate representation of the virgin or historical stress state that has developed in the rock mass over geologic history, prior to the onset of any human activity. The process of establishing this initial stress state within a numerical model is known as stress initialization.

Conventional approaches to stress initialization are highly simplified and are unable to realistically reflect a geological system. Poor stress initialization affects the accuracy of numerical models, introducing challenges in the use of and limiting confidence in such models as a tool for understanding and/or predicting rock mass behavior.

Accordingly, it would be useful to provide improved techniques for the initialization of geologically realistic in situ stress applied to numerical models.

### SUMMARY

In some embodiments, the methods and systems described herein can be used to initialize stress conditions in a numerical model with the objective of defining a geomechanical system representative of the natural geological environment. A strain-based stress initialization approach is provided, that captures virgin state stress gradients associated with stiffness and competency contrasts across geological, geomechanical and/or geotechnical domains and/or geological structures in the numerical model. Using this approach, strain is applied to the system to induce stress conditions within the numerical model that may be more consistent with actual conditions that have developed over the site geological history. Advantageously, the methods and systems described herein enable stresses within individual domains and across boundaries and contacts of the geomechanical system to initialize in a more natural, non-uniform manner. In this regard, outputs of the numerical model may be more accurate and may inform improved geomechanical design and associated operational decisions, for example, pertaining to mining or tunneling planning and/or operations.

Examples of the disclosed strain-based in situ stress initialization system enable improved or optimized designs and operations corresponding to mining, geotechnical or civil engineering applications by improving the performance of numerical models, helping to improve safety, reduce costs and downtime, improve efficiency, or mitigate geomechanical risks in such applications. Improving the accuracy, quality and efficiency of model simulations also increases computing efficiency (e.g., by reducing the number of iterations that are required to achieve a desired level of confidence for a predicted result, or by reducing the frequency of model calibration or model refinement), thereby reducing the use of computing resources (e.g., processing power, memory, computing time, etc.) and human resources (e.g., engineering effort) needed to initialize and run the numerical models. In this regard, more accurate model simulations and faster model computation provide tangible benefits to mining, geotechnical or civil engineering operations by informing physical steps of corresponding engineering design processes of the mining, geotechnical or civil engineering operations, for providing improved time and/or cost efficiency and safety in such operations.

In some example aspects, the present disclosure describes a computer-implemented method to initialize an in situ stress state in a numerical model. The method comprises: generating a numerical model representation of a geomechanical system including one or more geomechanical domains; generating a set of verified strain-initializing boundary conditions for initializing a stress state of the numerical model, based on material properties and constitutive models of the one or more geomechanical domains and a global stress tensor corresponding to the geomechanical system; simulating an in situ stress state of the numerical model by applying the verified strain-initializing boundary conditions to the numerical model; and outputting a simulated in situ stress tensor distribution based on the simulated in situ stress state.

In an example of the preceding example aspect of the method, further comprising: acquiring in situ observational data corresponding to the geomechanical system; calibrating the simulated in situ stress state, based on the in situ observational data; and outputting the simulated in situ stress tensor distribution based on the calibrated simulated in situ stress state.

In an example of a preceding example aspect of the method, further comprising: modifying an engineering design process based on the simulated in situ stress state.

In an example of the preceding example aspect of the method, further comprising: responsive to the engineering design process modification, receiving in situ observational data corresponding to the geomechanical system; updating the numerical model, based on the in situ observational data; and further modifying the engineering design process, based on the updated numerical model.

In an example of a preceding example aspect of the method, wherein generating the set of verified strain-initializing boundary conditions comprises: generating a set of initial strain-initializing boundary conditions for the numerical model, based on the material properties and constitutive models of the one or more geomechanical domains and the global stress tensor; assigning the initial strain-initializing boundary conditions to external boundaries of the numerical model, for initializing a stress state in the numerical model; and verifying the initial strain-initializing boundary conditions for the numerical model based on a comparison of the initialized stress state of the numerical model and a global stress target.

In an example of a preceding example aspect of the method, wherein simulating the in situ stress state comprises: applying a desired deformation at the boundaries of the numerical model based on the set of verified strain-initializing boundary conditions; fixing the desired deformation at the boundaries of the numerical model using zero normal-displacement boundary conditions or zero-displacement boundary conditions; allowing stresses to vary spatially in the numerical model over a plurality of time steps until an equilibrium is reached, wherein a resulting stress state in the numerical model at equilibrium represents the simulated in situ stress state.

In an example of the preceding example aspect of the method, wherein applying the desired deformation at the boundaries of the numerical model based on the set of verified strain-initializing boundary conditions comprises: applying displacements to the external boundaries of the numerical model; or applying velocity conditions to the external boundaries of the numerical model for a specified duration.

In an example of a preceding example aspect of the method, wherein the verified strain-initializing boundary conditions are defined in pairs and applied on opposing sides of the numerical model for initializing the stress state in the numerical model.

In an example of a preceding example aspect of the method, wherein the simulated in situ stress state varies spatially and is represented by the simulated stress tensor distribution.

In an example of a preceding example aspect of the method, wherein each of the one or more geomechanical domains includes unique material properties and constitutive models assigned heterogeneously.

In an example of a preceding example aspect of the method, wherein the material properties include rock mass Moduli of Deformation and Poisson's ratio.

In an example of the preceding example aspect of the method, wherein the numerical model incorporates anisotropic material stiffness, and the value of the rock mass Moduli of Deformation varies by orientation.

In some example aspects, the present disclosure describes a system. The device includes: one or more processor devices; and one or more memories storing machine-executable instructions, which when executed by the one or more processor devices, cause the system to: generate a numerical model representation of a geomechanical system including one or more geomechanical domains; generate a set of verified strain-initializing boundary conditions for initializing a stress state of the numerical model, based on material properties and constitutive models of the one or more geomechanical domains and a global stress tensor corresponding to the geomechanical system; simulate an in situ stress state of the numerical model by applying the verified strain-initializing boundary conditions to the numerical model; and output a simulated in situ stress tensor distribution based on the simulated in situ stress state.

In an example of the preceding example aspect of the system, wherein the machine-executable instructions, when executed by the one or more processor devices, further cause the system to: acquire in situ observational data corresponding to the geomechanical system; calibrate the simulated in situ stress state, based on the in situ observational data; and output the simulated in situ stress tensor distribution based on the calibrated simulated in situ stress state.

In an example of a preceding example aspect of the system, wherein the machine-executable instructions, when executed by the one or more processor devices, further cause the system to: modify an engineering design process based on the simulated in situ stress state.

In an example of the preceding example aspect of the system, wherein the machine-executable instructions, when executed by the one or more processor devices, further cause the system to: responsive to the engineering design process modification, receive in situ observational data corresponding to the geomechanical system; update the numerical model, based on the in situ observational data; and further modify the engineering design process, based on the updated numerical model.

In an example of a preceding example aspect of the system, wherein the machine-executable instructions, when executed by the one or more processor devices to generate the set of verified strain-initializing boundary conditions, further cause the system to: generate a set of initial strain-initializing boundary conditions for the numerical model, based on the material properties and constitutive models of the one or more geomechanical domains and the global stress tensor; assign the initial strain-initializing boundary conditions to external boundaries of the numerical model, for initializing a stress state in the numerical model; and verify the initial strain-initializing boundary conditions for the numerical model based on a comparison of the initialized stress state of the numerical model and a global stress target.

In an example of a preceding example aspect of the system, wherein the machine-executable instructions, when executed by the one or more processor devices to simulate the in situ stress state, further cause the system to: apply a desired deformation at the boundaries of the numerical model based on the set of verified strain-initializing boundary conditions; fix the desired deformation at the boundaries of the numerical model using zero normal-displacement boundary conditions or zero-displacement boundary conditions; allow stresses to vary spatially in the numerical model over a plurality of time steps until an equilibrium is reached, wherein a resulting stress state in the numerical model at equilibrium represents the simulated in situ stress state.

In an example of the preceding example aspect of the system, wherein the machine-executable instructions, when executed by the one or more processor devices to apply the desired deformation at the boundaries of the numerical model based on the set of verified strain-initializing boundary conditions, further cause the system to: apply displacements to the external boundaries of the numerical model; or apply velocity conditions to the external boundaries of the numerical model for a specified duration.

In some example aspects, the present disclosure describes a non-transitory computer readable medium storing instructions thereon. The instructions, when executed by one or more processors, cause the processor to: generate a numerical model representation of a geomechanical system including one or more geomechanical domains; generate a set of verified strain-initializing boundary conditions for initializing a stress state of the numerical model, based on material properties and constitutive models of the one or more geomechanical domains and a global stress tensor corresponding to the geomechanical system; simulate an in situ stress state of the numerical model by applying the verified strain-initializing boundary conditions to the numerical model; and output a simulated in situ stress tensor distribution based on the simulated in situ stress state.

### BRIEF DESCRIPTION OF THE DRAWINGS

Reference will now be made, by way of example, to the accompanying drawings which show example implementations of the present application, and in which:

FIG. 1A shows an example of a resource extraction system 100 for extracting a natural resource material from a subterranean formation.

FIG. 1B shows an example of spatial volumes that represent geomechanical or geological domains, within which the resource extraction system of FIG. 1A may be modeled as a 3D geomechanical system.

FIG. 2 is a block diagram of an example computing system suitable for implementation of examples described herein.

FIG. 3 is a block diagram of an architecture of an example strain-based stress initialization system, in accordance with example implementations described herein.

FIG. 4 is a block diagram of an example verification module of the strain-based initialization system of FIG. 3, in accordance with example implementations described herein.

FIG. 5 is a flowchart showing operations of a method for strain-based initialization of a stress state, in accordance with example implementations described herein.

Similar reference numerals have been used in different figures to denote similar components.

### DESCRIPTION OF EXAMPLE IMPLEMENTATIONS

The following describes example technical solutions of this disclosure with reference to accompanying figures.

The undisturbed or virgin (e.g., pre-mining or pre-construction) far-field stress state in a rock mass is spatially complex and rarely homogeneous. Virgin stresses are impacted by numerous factors; particularly historical geological processes which may be very complex. In situ stresses are imposed by the weight of overlying strata as well as various geological processes including active and paleo plate tectonics, glacial loading, erosional events, etc. The distribution of in situ stresses is complicated at multiple scales by additional second and third order factors. Stress gradients (and rotations) occur between lithological units and across geological structures due to contrasting stiffness and the natural strain history of a rock mass. Locally, heterogeneities, fabric, and discontinuities may further complicate stress tensor conditions. This means that at scales that may be in the order of many kilometers, regional lithology, stratigraphic and structural features will influence broad in situ stress variability, and at scales that may be in the order of meters (or less), contact, structures, grains, etc. introduce local-scale heterogeneity to in situ stress conditions.

In situ stress can be measured by instrumentation and laboratory testing methods. However, in situ stress state is a very data limited component of geomechanical site characterization. Over the scale of a resource extraction operation (e.g., over the entirety of an open-pit or underground mine) or another geotechnical operation, it is uncommon to have a large dataset of measurements representative of local in situ stress state. Inherent costs and difficulties with achieving reliable measures of a global stress tensor (e.g., a generalized stress state for a volume of interest, such as a volume represented by a numerical model), while capturing spatial variability contribute to this challenge.

Geomechanical numerical stress models are generally intended to provide computational evaluations of the redistribution of in situ stress around underground and surface openings, such as excavations in rock, as well as the imposed strain and material damage accumulation. As such, numerical models provide a valuable tool for engineers to design and plan rock excavation construction projects or mining operations while managing risk, for example, by modeling the stress redistribution that occurs due to activities over the lifetime of a mining or geotechnical operation. Accurate, and reliable numerical models require a coherent representation initial stress state (e.g., knowledge of the magnitude, gradients and direction of the in situ virgin stress tensor distribution) to be established within the model, that agrees with the virgin or historical stress state that has developed in the rock mass over geologic history, in order to effectively quantify and understand any changes in the stress state due to operational activity (e.g., resource extraction, excavation, etc.).

Unfortunately, accurate stress initialization is often neglected during numerical modeling, and only qualitatively accounted for with conceptual considerations during a geomechanical design process. This negatively affects the accuracy of numerical models and introducing challenges in the use of such models as a tool for understanding and/or predicting rock mass behavior during the planning of mining, geotechnical or civil engineering operations. In this regard, inaccurate numerical models may hinder the performance of geomechanical and/or engineering design processes, for example, potentially increasing operational costs, reducing operational efficiency and compromising operational safety.

Conventional approaches to initialize the virgin in situ stresses in the numerical model rely on simplified homogeneous assumptions. For example, it is standard engineering practice to initialize in situ stress within a numerical simulation by assigning either homogeneous magnitudes and tensor orientation throughout the numerical domain, or by formulating gradients associated with depth to allow for cumulative stress increases with increased distance below the earth's surface (again with fixed tensor orientations). In examples, these simplified approaches may rely on assumptions regarding overburden weight and/or simplified relationships between horizontal and vertical stresses (e.g., horizontal-to-vertical stress ratios or stress orientations). For example, a first existing stress-initialization approach applies a constant stress, via constant stress tensor magnitudes and orientations throughout all geological, geomechanical or geotechnical domains within a numerical model. A second existing stress-initialization approach applies a gradient stress, via constant stress tensor orientations throughout the modelling domain, where stress tensor magnitudes increase with depth. A third existing stress-initialization approach includes an initial stress state that varies by material domain. For example, employing similar general approaches as described in the first and second approach above for each separate geological, geomechanical or geotechnical domain in the model (e.g., applying a constant or homogeneous stress tensor throughout each geological, geomechanical or geotechnical domain in the model, where no spatial variability is imposed according to the geometry of domain boundaries or material parametric changes across boundaries). Accordingly, conventional approaches for stress initialization are unable to realistically represent a natural geological system, posing challenges for resource extraction operations and construction projects in rock masses with complex geological structures and domain heterogeneity. Indeed, the impact of in situ stress simplification on ground behavior predictions can lead to misinterpretation of complex rock failure processes. For the purpose of the present disclosure, the terms geological domain, geomechanical domain and geotechnical domain may be used interchangeably.

In some embodiments, the present disclosure describes examples that address some or all of the above drawbacks of existing stress state initialization approaches.

To assist in understanding the present disclosure, some relevant terminology that may be related to examples disclosed herein is presented.

In the present disclosure, a “global stress tensor” can mean: a term that refers to the generalized stress state for a volume of interest that is represented by a numerical model.

In the present disclosure, “material properties” can mean: a property or measurable characteristic of a material, such as a physical property (e.g., density, porosity, permeability etc.), a mechanical property (e.g., strength, elasticity, bulk modulus, Poisson's ratio, Young's modulus etc.).

In the present disclosure, “constitutive models” can mean: a mathematical model that describes the mechanical properties of a material or relationships between properties representing aspects of a material's behavior.

In the present disclosure, “boundary conditions” or “loading conditions” can mean: the constraints that are applied at a boundary of a system for describing how a system behaves on its boundaries, for example, external forces or displacements applied to a boundary of the system to induce stresses, strains, displacements, or other responses in the system. In the present disclosure, loading conditions and boundary conditions are considered interchangeable.

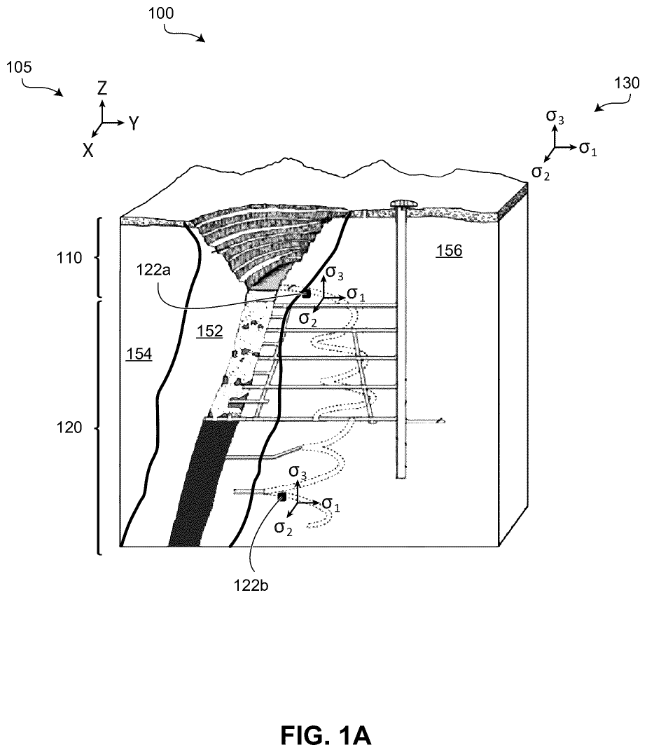

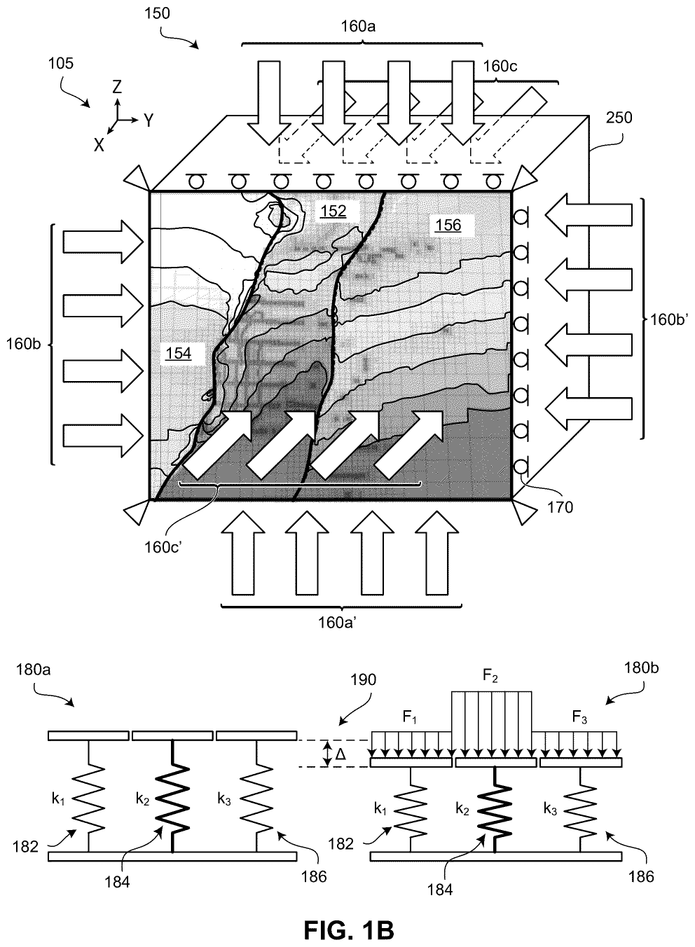

FIG. 1A shows a resource extraction system 100 for extracting a natural resource material from a subterranean formation, for example, incorporating an open pit mining operation 110 and an underground mining operation 120. The resource extraction system 100 is an illustrative example of a geological environment including three domains (e.g., a first domain 152, a second domain 154 and a third domain 156) that may be modeled as a geomechanical system, to which the systems, methods, and processor-readable media described herein can be applied, in accordance with examples of the present disclosure. It is understood that although the resource extraction system 100 is described in the context of a mining operation, other systems, for example, representing geotechnical, civil or geoengineering applications, may be used.

In some embodiments, for example, the resource extraction system 100 includes the underground mining operation 120 including underground infrastructure (e.g., tunnels, shafts, supports etc.) for accessing and removing a minable source of a natural resource material (e.g., an ore containing rock). The geological domains and the mining operation may represent a geomechanical system for which engineers have an understanding of global far-field in situ stress state according to regional trends and/or local measurements. For example, a global stress tensor 130 describing the generalized or “average” in situ stress tensor state encompassed by the model described by components of such as vertical and horizontal stresses and/or maximum, minimum and intermediate principal stresses, and corresponding orientations. Site-specific measurements may also be achieved by instrumentation (e.g., including sensors 122a, 122b may be installed, or testing conducted, at various locations within the resource extraction system 100 for obtaining local observational data, such as local stress measurements).

FIG. 1B shows an example of spatial volumes that represent geomechanical or geological domains, within which the resource extraction system 100 of FIG. 1A may be modeled as a 3D geomechanical system 150. For example, a global model bounded by external model boundaries may have a volume and internal geometries representing geological features and contacts defined by geometric dimensions in a coordinate space 105 (e.g., dimensions X, Y and Z for a 3D model, however it is understood that other shapes may be used, such as 2D representations). The geomechanical system 150 is an illustrative example of a system to which the systems, methods, and processor-readable media described herein can be applied, in accordance with examples of the present disclosure.

In examples, the geomechanical system 150 may be represented by the numerical model 250. In examples, the numerical model 250 may comprise one or more model domains (e.g., a first domain 152, a second domain 154 and a third domain 156, among other possibilities), for example, representative of different geometric components (e.g., lithologies, structures and/or alteration zones etc.) within the geomechanical system 150 or the geomechanical system represented in the numerical model 250 may be defined by a block model representing spatial variance in the composition of the geological or geotechnical domain components. In examples, during a strain-based stress initialization process, boundary conditions (e.g., loading conditions) may be defined for the numerical model 250. For example, assigning velocity or deformation boundary conditions to the numerical model 250, causes strain to be initialized within the geomechanical system 150. For example, responsive to applying a deformation to an external boundary of the numerical model 250, strain is initialized in the numerical model 250, which induces in situ stresses throughout the numerical model 250. In some embodiments, for example, boundary conditions may be defined in pairs that are applied on opposing sides of the numerical model 250, for example, where the boundary condition pairs are applied normal to the model surface and may or may not be equal in magnitude (provided the combined magnitudes induce the necessary strain to achieve the target in situ stress conditions). In the example of FIG. 1B, boundary conditions 160a and 160a′ are shown corresponding to a top and bottom external boundary of the numerical model 250, boundary conditions 160b and 160b′ are shown corresponding to left and right side external boundaries of the numerical model 250, and boundary conditions 160c and 160c′ are shown corresponding to front and back side external boundaries of the numerical model 250, however it is understood that other boundary condition arrangements may be used. In some embodiments, for example, one or more external boundaries of the numerical model 250 may be fixed, for example, using pins or rollers 170 as shown in FIG. 1B, or one or more external boundaries of the numerical model 250 may be a free boundary (for example, a topographic surface). Further, responsive to applying a predetermined strain (e.g., a target strain capable of inducing a desired deformation at the boundary), the boundary conditions may be changed to pins or rollers to “fix” the boundaries and the model is equilibrated (e.g., allowed to reach equilibrium) in order to “lock in” a strain-initialized stress state, among other possibilities. In examples, the boundary conditions (e.g., 160a, 160a′, 160b, 160b′, 160c and/or 160c′) contribute to a strain-induced in situ stress state in the numerical model 250 that more accurately captures the virgin stress state (or stress gradients) associated with material stiffness and competency contrasts in the geomechanical system 150, and is therefore more consistent with the natural geological setting. In examples, contours defining a spatially variable stress state in the numerical model 250 are provided in FIG. 1B for illustrative purposes.

To simplify this concept, consider a system with springs, for example, shown in an initial or unloaded state as system 180a. If a constant deformation (A) is applied to three springs (e.g., springs 182, 184 and 186) each with varying stiffness (e.g., k₁, k₂ and k₃, respectively) the resulting spring loads (e.g., represented by forces F₁, F₂ and F₃ in system 180b, for example, as shown in a loaded state, where the length of the arrows indicate a magnitude of applied force) will vary. Similarly, referring to the geomechanical system 150, responsive to assigning boundary conditions to boundaries of the numerical model 250 to initialize a predetermined strain at the boundary of the numerical model 250, the respective elastic properties (or other material properties) of the one or more geomechanical domains (e.g., domains 152, 154 and 156) may cause the resulting stresses in each domain to vary.

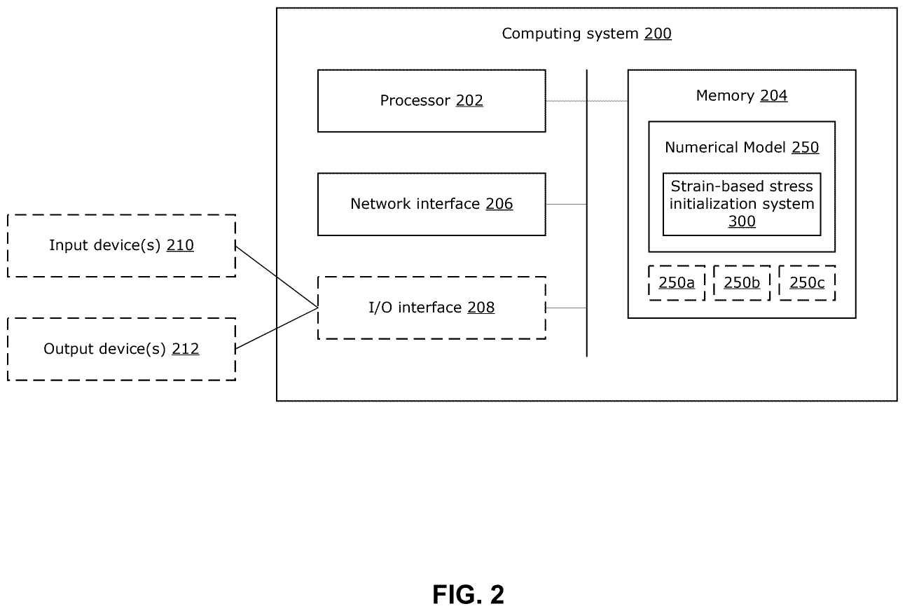

FIG. 2 is a block diagram illustrating an example hardware structure of a computing system 200 that is suitable for implementing example embodiments. In some implementations, computing system 200 can be an electronic computing device, such as a networked server or a single computer. In other implementations, the computing system 200 can be a distributed computing system including multiple devices (such as a cloud computing platform) or a virtual machine running on one or more devices in mutual communication over a network. Other examples suitable for implementing implementations described in the present disclosure can be used, which can include components different from those discussed below. Although FIG. 2 shows a single instance of each component, there can be multiple instances of each component in the computing system 200.

The computing system 200 includes at least one processor 202, such as a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 200 can include one or more network interfaces (collectively referred to as network interface 206) for wired or wireless communication over a network. The network interface 206 can include wired links (e.g., one or more ethernet cables) and/or wireless links (e.g., one or more antennas). The computing system 200 can communicate with one or more user devices (such as user workstation computers) via the network interface 206. The computing system 200 can also communicate with various sensors or other data sources via the network interface 206. In some embodiments, the sensors can include sensors located within the resource extraction system 100, for example, sensors 122a, 122b for monitoring the resource extraction system 100, including acquiring in situ monitoring data or observational data 350, such as for sensing deformation, strain or seismicity in the rock mass.

The computing system 200 may include an input/output (I/O) interface 208, which may enable interfacing with an optional input device 210 and/or an optional output device 212. In the example shown, the optional input device 210 (e.g., a keyboard, a mouse, a microphone, a camera, a scanner (e.g., optical scanner, LIDAR etc.), a touchscreen, and/or a keypad) and the optional output device 212 (e.g., a display, a speaker and/or a printer) are shown external to the computing system 200. In other example embodiments, there may not be any input device 210 and output device 212, in which case the I/O interface 208 may not be needed.

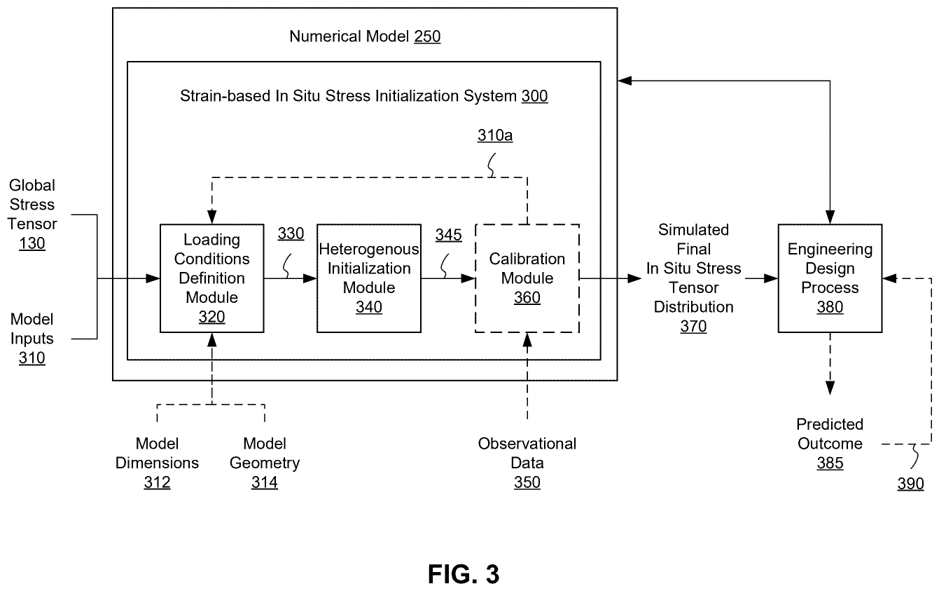

The computing system 200 may include one or more memories 204 (individually or collectively referred to as “memory 204”), which may include a volatile or non-volatile memory (e.g., a flash memory, a random-access memory (RAM), and/or a read-only memory (ROM)). The non-transitory memory 204 may store instructions for execution by the processor 202, such as to carry out example embodiments. For example, the memory 204 may store instructions for implementing the numerical model 250 (or optionally numerical models 250a, 250b or 250c), and/or a strain-based in situ stress initialization system 300, described with respect to FIG. 3 below. The memory 204 may include other software instructions, such as for implementing an operating system (OS) and other applications/functions.

In some examples, the computing system 200 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computing system 200) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The memory 204 can also store information or data used in executing the strain-based in situ stress initialization system 300, for example, a global stress tensor 130, model inputs 310 and optionally, observational data 350. The components of the computing system 200 may communicate with each other via a bus, for example.

FIG. 3 is a block diagram of an architecture of an example strain-based in situ stress initialization system 300 of the present disclosure. The strain-based in situ stress initialization system 300 can be a software that is implemented in the computing system 200 of FIG. 2, in which the processor 202 is configured to execute instructions of the strain-based in situ stress initialization system 300 stored in the memory 204. Although the strain-based in situ stress initialization system 300 is shown as a component of the numerical model 250, it is understood that the strain-based in situ stress initialization system 300 may be external to the numerical model 250 and may be configured to cooperate with the numerical model 250, or the strain-based in situ stress initialization system 300 may be integrated within the numerical model 250. The strain-based in situ stress initialization system 300 in the example of FIG. 3 includes a loading condition definition module 320, a heterogeneous initialization module 340 and an optional calibration module 360 and generates a simulated in situ stress tensor distribution 370 corresponding to the numerical model 250.

In examples, the numerical model 250 may be a 3D numerical model, where the external frame of the numerical model 250 is defined by a cuboid or rectangular prism and the internal model geometry 314 is defined by geomechanical domains within the geomechanical system 150 having respective material properties and constitutive models. In examples, the geometry 314 of the numerical model 250 may be constructed by first constructing a virtual model geometry according to the geomechanical domains, and then defining material parameters and constitutive models for each domain within the numerical model 250. The construction of the model geometry 314 comprises converting the model space to a meshed continuum which may include discrete contact elements. In other embodiments, construction of the model geometry 314 may correspond to a particle or pure discontinuum model, among other possibilities. The model space needs to be of sufficient volume to represent the geological area of interest, which may vary from many meters to many kilometers depending on the geomechanical design application (e.g., mining operation, tunnel construction etc.).

In examples, geomechanical domains of the numerical model 250 may represent volumes of a 3D model space, where each geomechanical domain includes unique material properties and constitutive models assigned homogeneously (e.g., constant through a domain volume) or heterogeneously (e.g., spatially varying within a domain volume). For example, the geomechanical domains may be 3D representations of lithologies, structures and/or alteration zones, etc. In examples, a geomechanical solid model (e.g., including 3D-volumes) or block model may be relied on to define spatial variance in material properties and/or constitutive models. In examples, parameters defined within material properties and constitutive models for each geomechanical domain may be obtained from various sources, such as mapping and drill core logging, or using geophysics or other instrumentation or laboratory testing and may reflect heterogeneities across the geomechanical domains.

In some embodiments, for example, the loading condition definition module 320 may receive as input, a global stress tensor 130 and model inputs 310 (e.g., including material properties and constitutive models corresponding to the geomechanical domains of the numerical model 250), and in cooperation with the numerical model 250, may output a set of verified strain-inducing boundary conditions 330 for initializing a stress state of the numerical model 250. In examples, the global stress tensor 130 may be estimated for a region of interest associated with the geomechanical system 150 (e.g., represented by the numerical model 250), for example, in proximity to a natural resource extraction operation (e.g., a mining operation, a hydrocarbon extraction operation, etc.) or a geomechanical application (e.g., a structure, a tunnel etc.) among others. In examples, the global stress tensor 130 may be estimated using regional stress tensor data obtained via review of literature or published data (e.g., scientific publications, technical reports, geological maps, stress testing databases, available geological models, etc.), or by local or site specific in situ stress testing data. For example, far field in situ stresses generally follow broad regional trends according to the depositional, tectonic, erosional and glaciation history of a geological environments. In examples, the global stress tensor 130 may describe the stress state of the geological environment in terms of principle stresses, for example, the global stress tensor 130 may be transformed into its principal axis system, including magnitudes and orientations of Major, Minor and Intermediate stress (σ₁, σ₂ and σ₃, respectively) or stresses resolved to vertical stress σᵥ and two horizontal principal stresses (σ_{Hmax} and σₕₘᵢₙ) with defined orientation trends. Example implementations of methods for generating the set of verified strain-initializing boundary conditions 330 will now be described, with reference to the loading conditions definition module 320 executed by the example computing system 200.

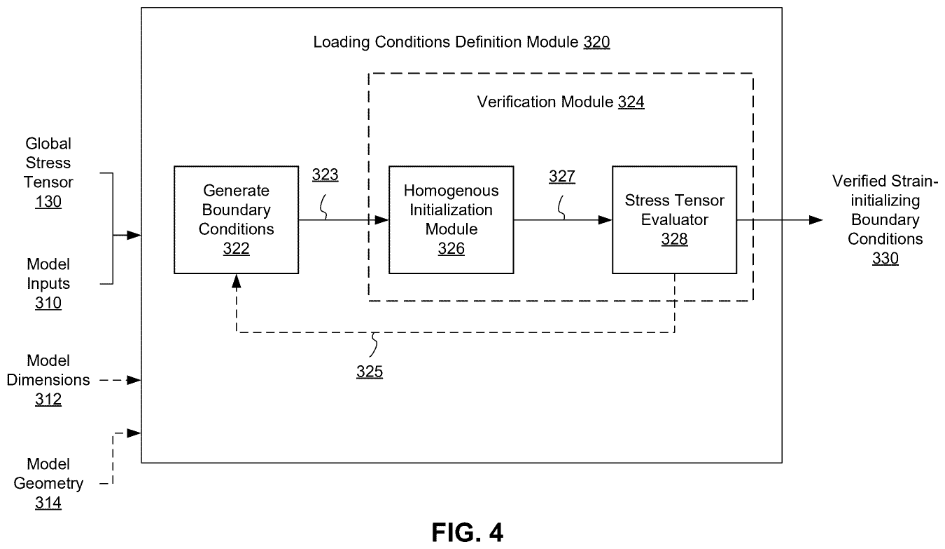

FIG. 4 is a block diagram of an example loading conditions definition module 320 of the present disclosure. The loading conditions definition module 320 can be a software that is implemented in the computing system 200 of FIG. 2, in which the processor 202 is configured to execute instructions of the verification module 320 stored in the memory 204. Alternatively, components of the loading conditions definition module 320 may be executed external to the computing system 200.

In examples, a generate boundary conditions block 322 of the loading conditions definition module 320 may receive the global stress tensor 130 and the model inputs 310 (e.g., including the material properties and constitutive models) and optionally, the model dimensions 312 of the numerical model 250 or model geometry 314 defined by geomechanical domains of the geomechanical system 150 for generating a set of initial strain-initializing boundary conditions 323. Optionally, the loading conditions definition module 320 may cooperate with the numerical model 250 to obtain the model dimensions 312 (e.g., X, Y, and Z) of the numerical model 250, or the model dimensions 312 of the numerical model 250 may be received via a user interface (not shown) of the loading conditions definition module 320, among other possibilities. In examples, the loading conditions definition module 320 may obtain, based on the global stress tensor 130, a target stress state consistent with a spatial coordinate system of the numerical model 250 (e.g., stress magnitudes σₓ, σ_{y}, σ_{z} where x, y and z represent axes of the spatial coordinate system). In examples, the model inputs 310 may include values of one or more parameters, for example, rock mass Modulus of Deformation Eᵣₘ, Poisson's ratio v, among other parameters, corresponding to each geomechanical domain of the numerical model 250.

In examples, a set of target displacements (e.g., Δx_{target}, Δy_{target}, Δz_{target}, where x, y and z represent axes of the spatial coordinate system) may be determined for the x, y and z directions using the following relationships provided in equations 1-3 below.

$$\frac{{σ}_{x}}{{E}_{rm \_ g}} = \frac{Δ {x}_{target}}{X} , \qquad ( 1 )$$

$$\frac{{σ}_{y}}{{E}_{rm \_ g}} = \frac{Δ {y}_{target}}{Y} , \qquad ( 2 )$$

$$\frac{{σ}_{z}}{{E}_{rm \_ g}} = \frac{Δ {z}_{target}}{Z} , \qquad ( 3 )$$

where E_{rm_g} is a representative global rock mass Modulus of Deformation value across all geomechanical domains in the numerical model 250, for example, representing an isotropic material stiffness and X, Y and Z represent dimensions 312 (or lengths) of the numerical model 250, in x, y and z directions, respectively, and σₓ, σ_{y}, σ_{z} represent stress magnitudes in the x, y and z directions corresponding to a target stress state of the numerical model 250. In examples, the loading conditions definition module 320 may cooperate with the numerical model 250 to determine a set of homogenous material properties from the model inputs 310 (e.g., from the material properties and constitutive models corresponding to the geomechanical domains of the numerical model 250), for example, by computing for each material property, a statistically representative value across all blocks of the numerical model 250, or the representative value may be determined external to the numerical model 250.

In some embodiments, for example, the numerical model 250 may incorporate anisotropic material stiffness, in which case the relationships described by equations 1-3 may instead be represented as shown in equations 4-6 below, where the value of rock mass Modulus of Deformation varies by orientation (in x, y and z directions) as E_{rm_gx}, E_{rm_gy} and E_{rm_gz}.

$$\frac{{σ}_{x}}{{E}_{rm \_ gx}} = \frac{Δ {x}_{target}}{X} \qquad ( 4 )$$

$$\frac{{σ}_{y}}{{E}_{rm \_ gy}} = \frac{Δ {y}_{target}}{Y} \qquad ( 5 )$$

$$\frac{{σ}_{z}}{{E}_{rm \_ gz}} = \frac{Δ {z}_{target}}{Z} \qquad ( 6 )$$

In examples, in generating the set of initial strain-initializing boundary conditions 323 for initializing the numerical model 250, consideration is given to Poisson's effect, for example, responsive to inducing a target strain in one of either the x, y or z directions, additional strain may be induced in the other two directions. In this regard, the set of initial strain-initializing boundary conditions 323 may be determined representative of the displacement applied to each boundary of the numerical model 250 (e.g., Δx_{applied}, Δy_{applied}, Δz_{applied}, where x, y and z represent axes of the spatial coordinate system) to achieve the target stress state (e.g., stress magnitudes σₓ, σ_{y}, σ_{z}), for example, as shown in equations 7-9 below.

$$Δ {x}_{applied} = Δ {x}_{target} - Δ {x}_{y} - Δ {x}_{z} \qquad ( 7 )$$

$$Δ {y}_{applied} = Δ {y}_{target} - Δ {y}_{x} - Δ {y}_{z} \qquad ( 8 )$$

$$Δ {z}_{applied} = Δ {z}_{target} - Δ {z}_{x} - Δ {y}_{y} \qquad ( 9 )$$

where Δx_{y}, and Δx_{z} represent the additional effective displacement induced in the x direction imposed by displacement in the y and z directions, respectively, Δyₓ, and Δy_{z} represent the additional effective displacement induced in the y direction imposed by displacement in the x and z directions, respectively, and Δzₓ, and Δz_{y} represent the additional effective displacement induced in the z direction imposed by displacement in the x and y directions, respectively.

In examples, the effective displacements may be determined, for example, based on Poisson's ratio v, the set of target strains (e.g., Δx_{target}/X, Δy_{target}/Y, Δz_{target}/Z) and the model dimensions 312 X, Y and Z, as shown in equations 10-15 below.

$$Δ {x}_{y} = \frac{v \times Δ {y}_{target} \times X}{Y} \qquad ( 10 )$$

$$Δ {x}_{z} = \frac{v \times Δ {z}_{target} \times X}{Z} \qquad ( 11 )$$

$$Δ {y}_{x} = \frac{v \times Δ {x}_{target} \times Y}{X} \qquad ( 12 )$$

$$Δ {y}_{z} = \frac{v \times Δ {z}_{target} \times Y}{Z} \qquad ( 13 )$$

$$Δ {z}_{x} = \frac{v \times Δ {x}_{target} \times Z}{X} \qquad ( 14 )$$

$$Δ {z}_{y} = \frac{v \times Δ {y}_{target} \times Z}{Y} \qquad ( 15 )$$

In some embodiments, the Poisson's ratio may be anisotropic, in which case equations 10 to 15 can be adjusted accordingly.

In some embodiments, for example, the applied displacements may be determined experimentally, for example, based on a trial-and-error approach. In examples, the applied displacements resolved using equations 10-15 (or alternately, determined experimentally), may be directly imposed on the numerical model boundaries (e.g., of numerical model 250), or resolved by applying velocity conditions to the model boundaries for a specified duration.

In some embodiments, for example, the effective vertical loading may be induced by applying a vertical force due to gravity (e.g., where body forces are required).

In examples, the strain-initializing boundary conditions 323 may be provided to the verification module 324 to verify whether the strain-initializing boundary conditions 323 can effectively initialize stress in the numerical model 250. For example, a homogenous initialization module 326 may run a simulation of numerical model 250 or a simulation of another numerical model (e.g., numerical model 250a) that is geometrically identical to numerical model 250 (e.g., with identical cuboid or rectangular prism geometry), but where each geomechanical domain of the model includes material properties and constitutive models assigned homogeneously, among other possibilities, for simulating an in situ stress state. For example, the homogenous initialization module 326 may assign a set of homogenous material properties (particularly Eᵣₘ) across all domains in the numerical model 250 (or 250a) and may assign displacement or velocity bounds to the numerical model 250 (or 250a), according to the initial strain-initializing boundary conditions 323. Once the strain-initializing boundary conditions 323 have been applied to the numerical model 250 (or 250a), the boundary conditions may be fixed (thereby, fixing a desired deformation at the boundaries of the numerical model 250 (or 250a)), for example, by changing the boundary conditions to roller (zero normal-displacement) or pinned (zero-displacement) conditions. In examples, responsive to fixing the boundary conditions using roller or pinned conditions, the simulation may proceed to equilibrate, for example, based on a time-stepping approach, where strain (and associated induced in situ stresses) may propagate through the numerical model over multiple time steps until reaching equilibrium, among other possibilities. In examples, the resulting in situ stress state at model equilibrium is a spatially variable stress state, for example, described by an in situ stress tensor distribution (e.g., preliminary in situ stress tensor distribution 327), and the homogenous initialization module 326 may output and provide the preliminary in situ stress tensor distribution 327 to a stress tensor evaluator 328 for comparing the preliminary in situ stress tensor distribution 327 to the global in situ stress targets as defined by the global stress tensor 130, for example, to obtain a global stress difference 325. In examples, the global stress difference 325 may be fed back to the generate boundary conditions 322 block for updating the strain-initializing boundary conditions 323.

In examples, the generation of the strain-initializing boundary conditions 323 may use an iterative approach, for example, responsive to determining, by the stress tensor evaluator 328, that the global stress difference 325 is above a threshold value, the strain-initializing boundary conditions 323 may be updated and the updated strain-initializing boundary conditions 323 may be re-applied to the numerical model 250 (or 250a). In examples, the global stress mismatch 325 may be a single value or may be a collection of values sampled at various locations throughout the numerical model 250 (or 250a). In examples, the stress tensor evaluator 328 may feed the global stress difference 325 back into the generate boundary conditions 322 block, for example, over a plurality of iterations, until the defined stress targets (e.g., represented by the global stress tensor 130) are adequately met. For example, to verify that the strain-initialized boundary conditions 323 enabled a successful initialization the numerical model 250 (or 250a) to achieve a global stress target, the strain-initialized boundary conditions 323 are iteratively updated until the global stress difference 325 is minimized or determined to be within or below a threshold value. In examples, when the global stress difference 325 criteria are satisfied, the loading conditions definition module 320 may output the updated set of strain-initializing boundary conditions 323 as a set of verified strain-initializing boundary conditions 330.

If the optional verification module 324 is not executed the initial strain-initializing boundary conditions 323 may be accepted as the verified strain-initializing boundary conditions 330.

Returning to FIG. 3, in some embodiments, for example, the heterogeneous initialization module 340 receives the set of verified strain-initializing boundary conditions 330 for inducing in situ stress within the numerical model 250. In some embodiments, for example, the heterogenous initialization module 340 may run a simulation of numerical model 250 or a simulation of another numerical model (e.g., numerical model 250b) that is geometrically identical to numerical model 250 (e.g., with identical cuboid or rectangular prism geometry), but where each geomechanical domain of the model includes material properties and constitutive models assigned heterogeneously, among other possibilities. For example, the heterogeneous initialization module 340 may cooperate with the numerical model 250 to determine a set of heterogenous material properties from the model inputs 310 (e.g., from the material properties and constitutive models corresponding to the geomechanical domains of the numerical model 250) and a simulation of the numerical model 250 (or 250b) may be performed by assigning the set of heterogenous material properties across corresponding domains or zones of the numerical model 250 (or 250b) and assigning displacement or velocity bounds to the numerical model 250 (or 250b), according to the verified strain-initializing boundary conditions 330. Once the verified strain-initializing boundary conditions 330 have been applied to the numerical model 250 (or 250b), the boundary conditions may be fixed (thereby, fixing a desired deformation at the boundaries of the numerical model 250 (or 250b)), for example, by changing the boundary conditions to roller (zero normal-displacement) or pinned (zero-displacement) conditions. In examples, responsive to fixing the boundary conditions using roller or pinned conditions, the simulation may proceed to equilibrate, for example, based on a time-stepping approach, where strain (and associated induced in situ stresses) may propagate through the numerical model 250 (or 250b) over multiple time steps until reaching equilibrium, among other possibilities. In examples, the resulting in situ stress state at model equilibrium is a spatially variable stress state, for example, described by an in situ stress tensor distribution, and the heterogenous initialization module 340 may output a simulated initial in situ stress tensor distribution 345 representative of the virgin in situ stress state within the geomechanical system 150.

In some embodiments, for example, an optional calibration module 360 may receive observational data 350 and may apply a calibration procedure to further refine or calibrate the simulated initial in situ stress tensor distribution 345. In examples, observational data 350 may include in situ monitoring data or other observations, for example, acquired by monitoring instrumentation, sensors etc. In examples, the calibration procedure may include updating model inputs 310 (e.g., updated model inputs 310a) and/or global stress tensor 130 and feeding the updated model inputs 310 and/or global stress tensor 130 back into the loading conditions definition module 320 for further updating the strain-initializing boundary conditions 323. For example, where in situ stress observations are available (e.g., in situ stress testing data, or ground reaction data to support mechanistic back analyses, such as observed ground behaviour, microseismic events, etc.), the calibration module 360 may perform a model calibration. This may be achieved directly by sampling local stress tensors resolved by the simulated initial in situ stress tensor distribution 345 at the representative locations of field in situ stress testing measurement, or alternatively, by back analysis of observed ground reaction history associated with historical mineral resource extraction, excavation activities, etc. In this regard, the updated model inputs 310a may include updated material properties and constitutive models for one or more domains of the numerical model, updated global stress tensor 130, updated strain-initializing boundary conditions 323, and/or updated geometry defined by geomechanical domains of geomechanical system 150.

The calibration module 360 enables improved confidence in the simulated final in situ stress tensor distribution 370. For example, the calibration module 360 may run a simulation of numerical model 250 that has been initialized based on the verified strain-based boundary conditions 330 (e.g., numerical model 250b) to generate the updated model inputs 310a or the calibration module 360 may apply the simulated initial in situ stress tensor distribution 345 to a different numerical model (e.g., numerical model 250c) which encompasses the same geometric space, or some part thereof. For example, in situ stress conditions described by the simulated initial in situ stress tensor distribution 345 may be imported and/or transferred to another numerical model 250c or model sub-set during execution of the calibration module 360 for generating the simulated final in situ stress tensor distribution 370.

In some embodiments, for example, if the optional calibration module 360 is not executed, the simulated initial in situ stress tensor distribution (345) may be accepted as the simulated final in situ stress tensor distribution (370).

In some embodiments, for example, the simulated final in situ stress tensor distribution 370 may be input to an engineering design process 380, for example, corresponding to operations of a mining, geotechnical or civil engineering application. Examples of the engineering design process 380 may include reliance on numerical, analytical or empirical design methods or tools to evaluate underground excavation stability (stopes, tunnels, chambers, etc.), evaluate open pit slope stability (particularly highwall slope stability in moderate to large open pit operations), design ground support systems, design rock burst mitigation methods, evaluate mining or construction methods to mitigate geomechanical and geotechnical hazards, geomechanically and geotechnically evaluate mine sequencing strategies, among other possibilities. It should be understood that these applications are only exemplary and are not intended to be limiting. In examples, the engineering design process 380 may require informed decision making, which may be supported directly by the simulated final in situ stress tensor distribution 370, or indirectly via numerical, analytical or empirical design methods and tools which have relied on the simulated final in situ stress tensor distribution 370, such as a model for simulating the engineering design that incorporates the simulated final in situ stress tensor distribution 370, among other possibilities. Within the context of executing an engineering design process 380, for example, numerical simulations may be conducted using numerical model 250b, for example, which has been initialized based on the verified strain-based boundary conditions 330, or the simulated final in situ stress tensor distribution 370 may be applied to a different numerical model (e.g., numerical model 250c or other) which encompasses the same geometric space, or some part thereof. For example, in situ stress conditions described by the simulated final in situ stress tensor distribution 370 may be imported and/or transferred to another numerical model or model sub-set for evaluating the engineering design and/or simulating the engineering design process 380.

For example, when the simulated final in situ stress tensor distribution 370 is relied on to evaluate changes to the geomechanical system 150 corresponding to a mining, geotechnical or civil engineering application, historical or future changes in local site conditions (e.g., change in material properties, simulated excavation geometries, changes to boundary effects such as seismic loading of ground water influences, etc.) may be input to the numerical model 250 (or other numerical models, e.g., 250c or other), or evaluated by kinematic or empirical design methods or tools to predict an outcome 385, such as excavation stability, seismic risk or hazard, among other outcomes, for example, corresponding to the operations of the mining, geotechnical or civil engineering application. In response to the predicted outcome 385, an engineering design process modification 390 can be evaluated and/or performed, causing a modification to be made to the engineering design process 380. In some embodiments, for example, the engineering design process modification 390 can include altering a development plan, such as layout, sequencing and timing of extraction operations, changing a blasting schedule, modifying planned or existing ground support, controlling ground water influences, among other possibilities. Advantageously, executing the engineering design process modification 390 may enable improved or optimized operations corresponding to the mining, geotechnical or civil engineering application, for example, by reducing downtime, improving efficiency, or mitigating risk, among other benefits.

In examples, the engineering design process modification 390 can be evaluated using the stress-initialized numerical model (e.g., numerical model 250, 250c or other) or other analytical or empirical design methods and tools, to predict the effect of performing the engineering design process modification 390, for example, for evaluating the predicted stress state or excavation stability within the geomechanical system 150 and to determine whether the engineering design process modification 390 should be performed. Engineering design process modifications 390 may be iteratively evaluated by the numerical model 250 (250c or other) or other analytical or empirical design methods and tools until a desired operational condition is obtained according to the engineering design and operational requirements of the mining, geotechnical or civil engineering application. In some embodiments, for example, evaluating the engineering design process modification 390 may be performed using the stress-initialized numerical model 250, or using another numerical model, for example, based on the simulated final in situ stress tensor distribution 370. For example, in situ stress conditions described by the simulated final in situ stress tensor distribution 370 may be imported and/or transferred to another numerical model or model sub-set. In further embodiments, responsive to performing the engineering design process modification 390, corresponding changes in the geomechanical system 150 caused by the engineering design process modification 390 may be measured or observed (e.g., as changes in local site conditions, for example, reflected by new or updated observational data 350 (such as in situ stress observational data), among other possibilities) and used to inform further engineering design process modifications 390. For example, data corresponding to an observed outcome of the engineering design process modification 390 on the engineering design process 380 may be input to the numerical model 250 (or other numerical models, e.g., 250b or 250c), or evaluated by kinematic or empirical design methods or tools to inform further engineering design process modifications 390. In this regard, the engineering design process 380 may be iteratively modified.

Example implementations of methods for simulating an in situ stress state based on the numerical model (e.g., numerical model 250 or 250b) that has been initialized using a strain-based stress initialization approach will now be described.

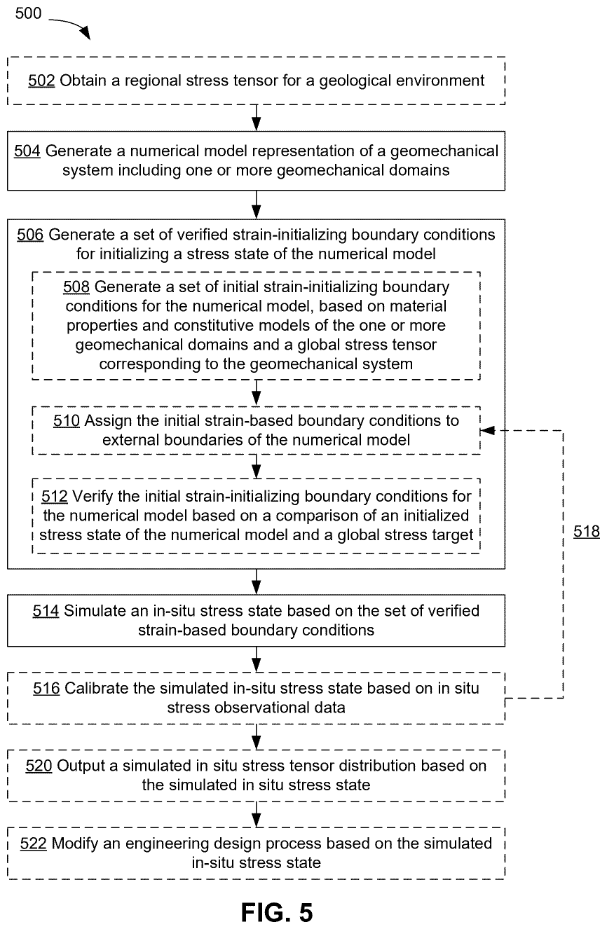

FIG. 5 is a flowchart showing operations of a method 500 for strain-based initialization of a numerically simulated in situ stress state, in accordance with examples of the present disclosure. The method 500 may be performed by the computing system 200. For example, the processor 202 of the computing system 200 of FIG. 2 may execute computer readable instructions (e.g., instructions of the strain-based in situ stress initialization system 300, which can be stored in the memory 204) to cause the computing system 200 to perform the method 500.

Method 500 begins at step 502 in which a global stress tensor 130 is obtained for a geological environment. In examples, the geological environment may be in proximity to a mining, geotechnical or civil engineering application, such as a natural resource extraction operation (e.g., a mining operation, a hydrocarbon extraction operation, etc.) or a structure, a tunnel etc., among other possibilities. In examples, the global stress tensor 130 may be estimated using regional or local stress tensor data obtained via review of literature or published data (e.g., scientific publications, technical reports, geological maps, stress testing databases, available geological models, etc.). For example, far field in situ stresses generally follow regional trends according to the depositional, tectonic, erosional and glaciation history of the geological environment. In examples, knowledge of geological processes which define regional orientations and magnitudes of the far field stress tensor may inform the estimated global stress tensor 130. In other examples, regional or site specific in situ stress testing data may inform the estimated global stress tensor 130.

At step 504, a numerical model 250 representation of the geomechanical system 150 may be generated. For example, the numerical model 250 may include model geometry 314 defined by one or more geomechanical domains having respective material properties and constitutive models, such as homogenous material properties or heterogenous material properties, among others.

At step 506, a set of verified strain-initializing boundary conditions 330 may be generated for initializing a stress condition or a stress state of the numerical model 250, based on material properties of the one or more geomechanical domains and the global stress tensor 130. In examples, the verified strain-initializing boundary conditions 330 may represent displacement or velocity boundary conditions for inducing strain within the numerical model 250 (e.g., in the form of a displacement applied at the boundaries of the numerical model), with effect that a stress state of the numerical model is initialized. In examples, the generation of the set of verified strain-inducing boundary conditions 330 may be described by steps 508-512.

At step 508, a set of initial strain-initializing boundary conditions 323 may be generated for the numerical model 250 based on the regional stress tensor 130 and model inputs 310 (e.g., including material properties and constitutive models for domains of the geomechanical system 150), for example, including rock mass Modulus of Deformation and Poisson's ratio. At step 510, the initial strain-initializing boundary conditions 323 may be applied to the numerical model 250 to induce an initialized stress state of the numerical model 250. In examples, the domains of the numerical model 250 may be characterized using homogenous or heterogenous material parameterization. In examples, the initialized stress state of the numerical model 250 may be compared with a global stress target, for example, to verify the strain-initializing boundary conditions. In examples, the verified strain-initializing boundary conditions 330 may represent isotropic or anisotropic conditions associated with domains of the numerical model 250.

At step 514, an in situ stress state of the numerical model 250 may be simulated based on the set of verified strain-initializing boundary conditions 330. For example, the set of verified strain-initializing boundary conditions 330 may be applied to the numerical model geometry 314. In examples, prior to the simulation, the domains of the numerical model 250 may be characterized using heterogenous material parameterization.

Optionally, at step 516, the simulated in situ stress state of the initialized numerical model 250 may be calibrated based on observational data 350, for example, pertaining directly to in situ stress, or by back analyses of ground reaction observations (e.g. using seismic data). In examples, observational data 350 may be acquired by monitoring instrumentation, sensors etc. or may include other in situ observations. In examples, the numerical model 250 may be updated based on the observational data 350 and/or back analyses, for example, by generating updated model inputs 310a (e.g., including updated material properties and constitutive models), revising the strain-initializing boundary conditions 323, and/or revising the geometry 314 defined by geomechanical domains of geomechanical system 150. At step 518, responsive to updating the numerical model 250, the method may return to step 510 where updated strain-initializing boundary conditions 323 may be generated, based on the updated model inputs 310a and/or reflecting any changes to the geometry 314 defined by geomechanical domains of geomechanical system 150, and the updated strain-initializing boundary conditions 323 may be applied to the numerical model 250 to induce a calibrated initialized stress state of the numerical model 250.

At step 520, a simulated in situ stress tensor distribution 370 may be output based on the simulated in situ stress state. In examples, the simulated in situ stress state is a spatially variable stress state, for example, which can be described by the in situ stress tensor distribution 370.

Optionally, at step 522, an engineering design process 380 may be modified based on the simulated in situ stress state. For example, the simulated final in situ stress tensor distribution 370 may be input to an engineering design process 380, for example, corresponding to operations of a mining, geotechnical or civil engineering application, and an engineering design modification 390 may be selected for implementation. For example, the engineering design process 380 may rely on numerical, analytical or empirical design methods or tools to evaluate and/or simulate potential engineering design modifications 390. In some embodiments, for example, an engineering design process modification 390 can represent a modification to a physical step in the engineering design process 380, such as altering a development plan, such as layout, sequencing and timing of extraction operations, changing a blasting schedule, modifying planned or existing ground support, controlling ground water influences, among other possibilities. In some embodiments, for example, the engineering design process 380 may be iteratively modified. For example, responsive to performing a first engineering design process modification 390, corresponding changes in the geomechanical system 150 caused by the engineering design process modification 390 may be measured or observed and used to inform further engineering design process modifications 390. For example, data corresponding to an observed outcome of the engineering design process modification 390 on the engineering design process 380 may be input to the numerical model 250 (or other numerical models, e.g., 250b or 250c), or evaluated by kinematic or empirical design methods or tools to inform further engineering design process modifications 390.

### General

Although the present disclosure describes functions performed by certain components and physical entities, it should be understood that, in a distributed system, some or all of the processes can be distributed among multiple components and entities, and multiple instances of the processes can be carried out over the distributed system.

Although the present disclosure describes methods and processes with steps in a certain order, one or more steps of the methods and processes can be omitted or altered as appropriate. One or more steps can take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, either by way of hardware components, software or any combination of the two. Accordingly, the technical solution of the present disclosure can be embodied in the form of a software product. A suitable software product can be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. In general, the software improves the operation of the hardware in one or more ways.

The present disclosure can be embodied in other specific forms without departing from the subject matter of the claims. The described example implementations are to be considered in all respects as being only illustrative and not restrictive. Selected features from one or more of the above-described implementations can be combined to create alternative implementations not explicitly described, features suitable for such combinations being understood within the scope of this disclosure.

All values and sub-ranges within disclosed ranges are also disclosed. Also, although the systems, devices and processes disclosed and shown herein can include a specific number of elements/components, the systems, devices and assemblies could be modified to include additional or fewer of such elements/components. For example, although any of the elements/components disclosed can be referenced as being singular, the implementations disclosed herein could be modified to include a plurality of such elements/components. The subject matter described herein intends to cover and embrace all suitable changes in technology.

1. A computer-implemented method comprising:
generating a numerical model representation of a geomechanical system including one or more geomechanical domains;
generating a set of verified strain-initializing boundary conditions for initializing a stress state of the numerical model, based on material properties and constitutive models of the one or more geomechanical domains and a global stress tensor corresponding to the geomechanical system;
simulating an in situ stress state of the numerical model by applying the verified strain-initializing boundary conditions to the numerical model; and
outputting a simulated in situ stress tensor distribution based on the simulated in situ stress state.

2. The method of claim 1, further comprising:
acquiring in situ observational data corresponding to the geomechanical system;
calibrating the simulated in situ stress state, based on the in situ observational data; and
outputting the simulated in situ stress tensor distribution based on the calibrated simulated in situ stress state.

3. The method of claim 1, further comprising:
modifying an engineering design process based on the simulated in situ stress state.

4. The method of claim 3, further comprising:
responsive to the engineering design process modification, receiving in situ observational data corresponding to the geomechanical system;
updating the numerical model, based on the in situ observational data; and
further modifying the engineering design process, based on the updated numerical model.

5. The method of claim 1, wherein generating the set of verified strain-initializing boundary conditions comprises:
generating a set of initial strain-initializing boundary conditions for the numerical model, based on the material properties and constitutive models of the one or more geomechanical domains and the global stress tensor;
assigning the initial strain-initializing boundary conditions to external boundaries of the numerical model, for initializing a stress state in the numerical model; and
verifying the initial strain-initializing boundary conditions for the numerical model based on a comparison of the initialized stress state of the numerical model and a global stress target.

6. The method of claim 1, wherein simulating the in situ stress state comprises:
applying a desired deformation at the boundaries of the numerical model based on the set of verified strain-initializing boundary conditions;
fixing the desired deformation at the boundaries of the numerical model using zero normal-displacement boundary conditions or zero-displacement boundary conditions;
allowing stresses to vary spatially in the numerical model over a plurality of time steps until an equilibrium is reached, wherein a resulting stress state in the numerical model at equilibrium represents the simulated in situ stress state.

7. The method of claim 6, wherein applying the desired deformation at the boundaries of the numerical model based on the set of verified strain-initializing boundary conditions comprises:
applying displacements to the external boundaries of the numerical model; or
applying velocity conditions to the external boundaries of the numerical model for a specified duration.

8. The method of claim 6, wherein the verified strain-initializing boundary conditions are defined in pairs and applied on opposing sides of the numerical model for initializing the stress state in the numerical model.

9. The method of claim 1, wherein the simulated in situ stress state varies spatially and is represented by the simulated stress tensor distribution.

10. The method of claim 1, wherein each of the one or more geomechanical domains includes unique material properties and constitutive models assigned heterogeneously.

11. The method of claim 1, wherein the material properties include rock mass Moduli of Deformation and Poisson's ratio.

12. The method of claim 11, wherein the numerical model incorporates anisotropic material stiffness, and the value of the rock mass Moduli of Deformation varies by orientation.

13. A system comprising:
one or more processor devices; and
one or more memories storing machine-executable instructions, which when executed by the one or more processor devices, cause the system to:
generate a numerical model representation of a geomechanical system including one or more geomechanical domains;
generate a set of verified strain-initializing boundary conditions for initializing a stress state of the numerical model, based on material properties and constitutive models of the one or more geomechanical domains and a global stress tensor corresponding to the geomechanical system;
simulate an in situ stress state of the numerical model by applying the verified strain-initializing boundary conditions to the numerical model; and
output a simulated in situ stress tensor distribution based on the simulated in situ stress state.

14. The system of claim 13, wherein the machine-executable instructions, when executed by the one or more processor devices, further cause the system to:
acquire in situ observational data corresponding to the geomechanical system;
calibrate the simulated in situ stress state, based on the in situ observational data; and
output the simulated in situ stress tensor distribution based on the calibrated simulated in situ stress state.

15. The system of claim 13, wherein the machine-executable instructions, when executed by the one or more processor devices, further cause the system to:
modify an engineering design process based on the simulated in situ stress state.

16. The system of claim 15, wherein the machine-executable instructions, when executed by the one or more processor devices, further cause the system to:
responsive to the engineering design process modification, receive in situ observational data corresponding to the geomechanical system;
update the numerical model, based on the in situ observational data; and
further modify the engineering design process, based on the updated numerical model.

17. The system of claim 13, wherein the machine-executable instructions, when executed by the one or more processor devices to generate the set of verified strain-initializing boundary conditions, further cause the system to:
generate a set of initial strain-initializing boundary conditions for the numerical model, based on and the material properties and constitutive models of the one or more geomechanical domains and the global stress tensor;
assign the initial strain-initializing boundary conditions to external boundaries of the numerical model, for initializing a stress state in the numerical model; and
verify the initial strain-initializing boundary conditions for the numerical model based on a comparison of the initialized stress state of the numerical model and a global stress target.

18. The system of claim 13, wherein the machine-executable instructions, when executed by the one or more processor devices to simulate the in situ stress state, further cause the system to:
apply a desired deformation at the boundaries of the numerical model based on the set of verified strain-initializing boundary conditions;
fix the desired deformation at the boundaries of the numerical model using zero normal-displacement boundary conditions or zero-displacement boundary conditions;
allow stresses to vary spatially in the numerical model over a plurality of time steps until an equilibrium is reached, wherein a resulting stress state in the numerical model at equilibrium represents the simulated in situ stress state.

19. The system of claim 18, wherein the machine-executable instructions, when executed by the one or more processor devices to apply the desired deformation at the boundaries of the numerical model based on the set of verified strain-initializing boundary conditions, further cause the system to:
apply displacements to the external boundaries of the numerical model; or
apply velocity conditions to the external boundaries of the numerical model for a specified duration.

20. A non-transitory computer-readable medium storing machine-executable instructions which, when executed by one or more processors, cause the processor to:
generate a numerical model representation of a geomechanical system including one or more geomechanical domains;
generate a set of verified strain-initializing boundary conditions for initializing a stress state of the numerical model, based on material properties and constitutive models of the one or more geomechanical domains and a global stress tensor corresponding to the geomechanical system;
simulate an in situ stress state of the numerical model by applying the verified strain-initializing boundary conditions to the numerical model; and
output a simulated in situ stress tensor distribution based on the simulated in situ stress state.
